(19) United States
(12) Patent Application Publication
(10) Pub. No.: US 2020/0193662 A1
(43) Pub. Date: Jun. 18, 2020

(54) VIDEO TRACKING SYSTEM AND DATA PROCESSING

(71) Applicant: Genvis Pty Ltd, West Leederville (AU)

(72) Inventor: Jakrin JUANGBHANICH, Yokine (AU)

(21) Appl. No.: 16/719,168

(22) Filed: Dec. 18, 2019

(30) Foreign Application Priority Data
Dec. 18, 2018 (AU) 2018904822

(51) Int. Cl. G06T 11/60; G06T 7/70; G06T 7/20

(52) U.S. Cl. CPC G06T 11/60; G06T 2207/30241; G06T 7/20; G06T 7/70

(57) ABSTRACT

Computer system and method for detecting and tracking events comprising one or more entities depicted in a video data stream comprising a background image including the entities, the computer system being adapted to receive the video data stream for processing thereof for detecting and tracking entities depicted in a video data stream from a camera that capture images from a particular scene (the input images) having a background image comprising entities such as persons and vehicles and where events such as movement of the entities may occur. The system processes the video data stream to generate the sensory representations to be displaced in a user interface operatively connected to the system. The sensory representations are then applied to the background image generating a visualised imagery for viewing by a viewer in the user interface.

### TECHNICAL FIELD

The present invention relates to video processing and video analytics for visualization of stationary or moving targets, events or actions.

The invention has been devised particularly, although not necessarily solely, in relation to system and methods for detecting and visualising actions, events, targets recorded in video data streams.

### BACKGROUND ART

The following discussion of the background art is intended to facilitate an understanding of the present invention only. The discussion is not an acknowledgement or admission that any of the material referred to is or was part of the common general knowledge as at the priority date of the application.

Current visualization methods in the context of video analytics are typically crude and unclear. An example of conventional video analytics is IBM's Intelligent Video Analytics platform. FIG. 1 shows an example of an image 1 generated with IBM's Intelligent Video Analytics platform.

It is noted that when using IBM's Intelligent Video Analytics platform the blue lines 2 (represented as black lines in FIG. 1) in image 1 show the trajectory of detected people in this video. But this style of visualisation when seen by a user on an actual screen has a few problems; in particular, it is unclear where each path starts and ends, and how these entities move across that path over time (for example if they stop or slow down). Additionally, the solid dark blue line (represented in FIG. 1 as a solid dark black line) when seen by a user on an actual screen does not contrast well against the darker colours of the road, which can make it difficult to see.

FIG. 2 shows another example of an image 3 generated with IBM's Intelligent Video Analytics platform. This image 3 shows bounding boxes 4a and 4b and image redaction capabilities 5. The problem with this style of visualisation is that, when seen by a user on an actual screen, the bounding boxes can be difficult to see if the colour contrast is poor. In this example, the yellow box (represented as a box defined with a border having a particular pattern) around the man's face when seen by a user on an actual screen does not have great visibility or clarity against the background. This is because the line defining the boundary is quite thin, and also because the yellow colour (represented by the pattern that define the border of the box) does not stand out against the white colour of the wall when seen by a user on an actual screen.

These are typical examples of current popular visualisation techniques in computer vision (for both object detection and tracking).

Presently, there exists computer software which can detect and track objects in a video data stream, using techniques such as deep convolutional neural networks. These objects can be of any arbitrary class (for example, face detection or vehicle detection). The input into such software is a video data stream, either live or recorded. The software will analyse the entire video, and produce data about which objects are being detected (object class), at what time (video frame index), and at which location (x, y positions, and width and height in pixels). In a purely text or numerical form, this data is difficult for human users to interpret, especially in the context of moving, sequential images (i.e. video). It is often the case, in the interest of human readability, that this data is visualised as an image or video overlay, using boxes and lines to indicate detected objects and their respective trajectories over time.

It is against this background that the present invention has been developed.

SUMMARY OF INVENTION

According to a first aspect of the invention there is provided a computer system for detecting and tracking events comprising one or more entities depicted in a video data stream comprising a background image including the entities, the computer system being adapted to receive the video data stream for processing thereof, and the computer system comprising:
a computing system comprising at least one processor for executing executable code and at least one memory device communicating with the processor accessible via a computer network and storing the executable code, wherein the executable code, when executed by the at least one processor, causes the at least one processor to:
a. scan the video data stream for detecting the one or more entities and one or more trajectories taken by the entities, and the background image;
b. process the detected entities, the trajectories, and the background image;
c. generate detection meta-data concerning detected entity and tracking meta-data concerning the detected trajectories;
d. generate meta-data representative of the background image;
e. process the meta-data for generating sensory representations, the sensory representations comprising any one of:
f. visual representations of the tracked events comprising a trace representative of the trajectory of the event, the trace being configured for representing the position of the entity over time along the trajectory;
g. visual representations configured for highlighting the entity in the background image; and
h. visualisation of the background image.

Preferably, the trace is configured in order to represent movement of the detected entity.

Preferably, the trace comprises a line.

Preferably, the thickness of the line varies in accordance with the movement of the detected entity to represent the position of the entity over time.

Preferably, the line comprises a starting point representing the start of the entity's trajectory, an ending point representing the end of the entity's trajectory, and a centre section representing the entity's trajectory between the start and end of the entity's trajectory, the line at its starting point being thinnest denoting the start of the entity's trajectory and the line at its ending point being thickest denoting the end of the entity's trajectory.

Preferably, the line comprises a cap at its starting point denoting the starting point of the line.

Preferably, the line comprises a cap at its ending point to denote the ending point of the line.

Preferably, the cap comprises an inner circle and an outer circle surrounding the inner circle in a concentric relationship with respect to each other, the inner circle and the outer circle being configured to show a contrast between both circles.

Preferably, a particular characteristic is assigned to each detected entity and that particular characteristic will be used continuously for the particular detected entity throughout the processing of the video data stream.

Preferably, the detected entities who share one or more attributes are assigned the same characteristic.

Preferably, the line and the cap are assigned the same characteristic.

Preferably, the particular characteristics comprise colour.

Preferably, the outer circle is of the same colour than the colour of the line, the colour of the line being darkened by 75%.

Preferably, the trace comprises a visual representation permitting identification of the entity.

Preferably, the visual representation permitting identification of the entity comprises the same characteristic than the line.

Preferably, the visual representation permitting identification of the entity comprises the face of the entity.

Preferably, the visual representation permitting identification of the entity comprises a geometric shape surrounding at least a portion of the entity.

Preferably, the visual representation permitting identification of the entity comprises generating a visualisation of the background image of the video stream.

Preferably, at least a portion of the background image located outside the geometric shape is darkened to improve the contrast between the geometric shape and the background image.

Preferably, the background image within geometric shape has not been visualised.

Preferably, the geometric shape comprises a padding located within the geometric shape, the padding defined by the visualised background.

Preferably, the visualisation of the background image comprises any one of desaturation of the background image and darkening of the background image.

Preferably, the visualisation of the background image may comprise selective visualisation.

Preferably, the visualisation process of the background image comprise generating a visual representation of the background image excluding the presence of the entities.

Preferably, the colour assigned to each visual representation of the entity and the trajectory is chosen from a generated bespoke colour palette.

Preferably, the colours of the bespoke colour palette are generated at a saturation level of between 80-100% and a brightness of 100%.

Preferably, each colour (of the generated bespoke colour palette) will only differ in its hue value.

Preferably, the executable code, when executed by the at least one processor, causes the at least one processor to generate a visualised imagery comprising visualised background image having applied thereon sensory representations of one or more detected entities and of the trajectories of the one or more detected entities.

Preferably, the characteristics for the visual representations will be applied onto the background image using additive blend mode.

Preferably, the visualised imagery comprises a static image.

Alternatively, the visualised imagery comprises a visualised video.

Preferably, the executable code, when executed by the at least one processor, causes the at least one processor to filter out from the visualised video particular instances of the video data stream.

Preferably, the filtering out comprises speeding up the visualised video.

Preferably, the visualised video, the traces (representing the trajectories of detected entities) may be rendered from their starting point and animated towards their ending point.

Preferably, the traces, when having reached their end portions, the thickness and opacity of the traces will slowly fade out over a relative short period of time.

According to a second aspect of the invention there is provided a method for detecting and tracking one or more entities depicted in a video data stream comprising a background image including the entities, the method comprises
a. scanning the video data stream for detecting the one or more entities and one or more trajectories taken by the entities, and the background image;
b. processing the detected entities, the trajectories, and the background image;
c. generating detection meta-data concerning detected entity and tracking meta-data concerning the detected trajectories;
d. generating meta-data representative of the background image;
e. processing the meta-data for generating sensory representations, the sensory representations comprising any one of:
f. visual representations of the tracked events comprising a trace representative of the trajectory of the event, the trace being configured for representing the position of the entity over time along the trajectory;
g. visual representations configured for highlighting the entity in the background image; and
h. visualisation of the background image.

Preferably, the method further comprises generating a visualised imagery comprising applying the sensory representations of the one or more detected entities and of the trajectories of the one or more detected entities on the visualised background image.

Preferably, the method further comprises generating a static image comprising the visualised imagery.

Preferably, the method further comprises generating a visualised video comprising the visualised imagery.

Preferably, the method further comprises filtering out from the visualised video particular instances of the video data stream.

Preferably, filtering out comprises speeding up the visualised video.

Preferably, in the visualised video, the traces are rendered from their starting point and animated towards their ending point.

Preferably, the traces have reached their end portions, the thickness and opacity of the traces will slowly fade out over a relative short period of time.

Preferably, a particular characteristic is assigned to each detected entity and that particular characteristic will be used continuously for the particular detected entity throughout the processing of the video data stream.

Preferably, the detected entities who share one or more attributes are assigned the same characteristic.

Preferably, the visualisation of the background image comprises any one of desaturation of the background image and darkening of the background image.

Preferably, the visualisation of the background image may comprise selective visualisation

Preferably, the visualisation process of the background image comprise generating a visual representation of the background image excluding the presence of the entities.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 shows a first example of an image generated with IBM's Intelligent Video Analytics platform;

FIG. 2 shows a second example of an image generated with IBM's Intelligent Video Analytics platform;

FIG. 3 shows a particular arrangement of a system for processing video data streams to generate meta-data and visualisation of the meta-data for generation of visualised imagery;

FIG. 4 shows a static image of a visualised imagery depicting a visual representation of a trajectory of a detected entity;

FIGS. 5a and 5b shows two static images of a visualised imagery depicting a detected entity highlighted by another visual representation;

FIG. 6 shows a static image of a visualised imagery depicting a visual representation of a plurality of trajectories of detected entities crossing a footpath;

FIG. 7 shows a static image of a visualised imagery depicting visual representations of trajectories of detected entities moving along an aisle of a supermarket;

FIG. 8 shows a static image of a visualised imagery depicting visual representations of detected entities highlighted by the another visual representations;

FIG. 9 shows a particular arrangement of a default characteristic palette, such as default colour palette;

FIG. 10 shows a particular arrangement of a branding characteristic palette, such as branding colour palette;

FIG. 11 shows a flowchart illustrating the process for rendering the bounding boxes;

FIG. 12 shows a flowchart illustrating the process for rendering the lines representing trajectories of detected entities; and

FIG. 13 shows a particular arrangement of the computing system comprising the system for generating the visualised imagery.

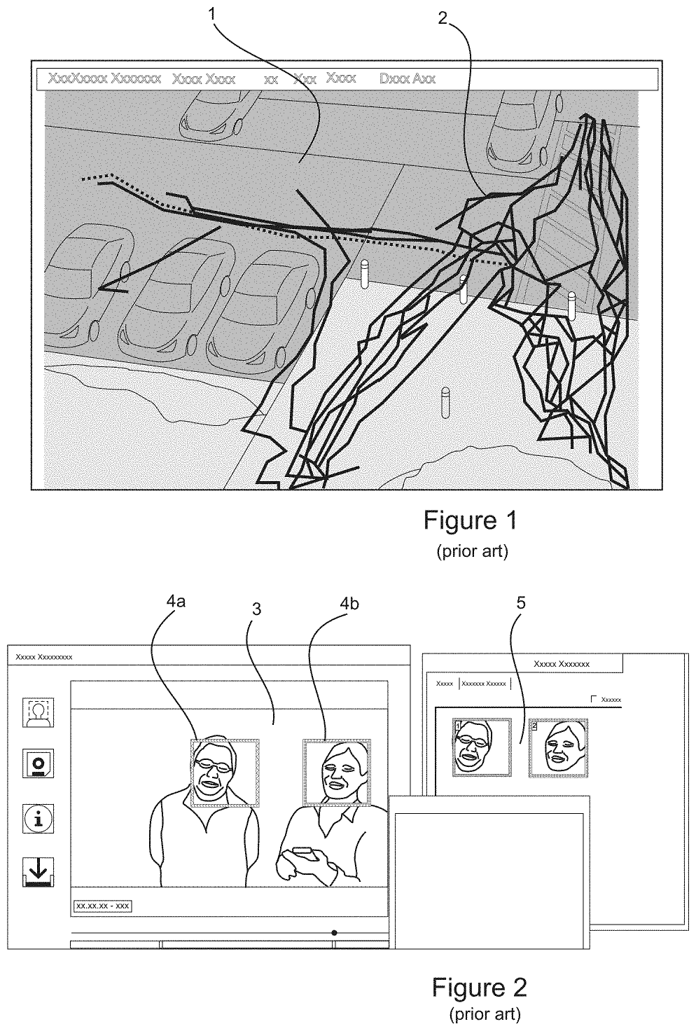

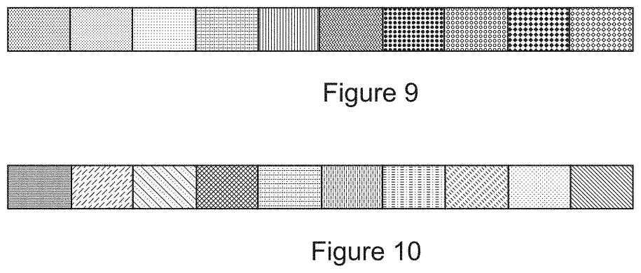

It should be noted that the figures are schematic only and the location and disposition of the components can vary according to the particular arrangements of the embodiments of the present invention as well as of the particular applications of the present invention. Moreover, as will be described below the visual representations may be assigned different characteristics to distinguish the visual representations from each other, the characteristic may be colours, gradient, texture and/or patterns among others. Due the Patent Cooperation Treaty not making any provisions for colour drawings per PCT Rule 11.13, the figures of the present application depict the characteristics as type of lines and patterns instead than colours as referred to in the following description. It is understood that in accordance with one particular arrangement each type of lines and each pattern represents a colour as chosen from a colour palette this is particularly true in relation to FIGS. 9 and 10. In an arrangement, for example, the colours in a particular colour palette differ with respect to each other only in their hue value. However, in alternative arrangements, the visual representations may be actually depicted, instead than colours, as having different characteristics such as types of lines and patterns.

### DESCRIPTION OF EMBODIMENT(S)

In accordance with a particular arrangement of an embodiment of the invention there is provided a computer-implemented method and the system 10 for implementing the method for detecting and tracking entities depicted in a video data stream 14.

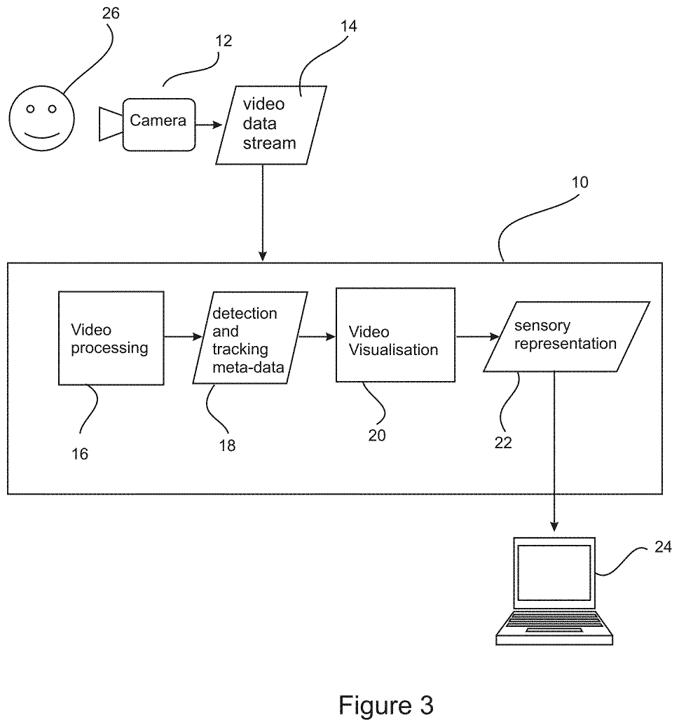

Referring to FIG. 3, the system 10 comprises a video processing sub-system 16 and a video visualisation sub-system 20 operatively connected to each other for interchanging information. The video processing sub-system 16 generates a meta-data 18 and the visualisation sub-system 20 generates sensory representations 22.

The video data stream 14 may be generated by the camera 12 and forwarded to a user in a form of a video file to be, for example, downloaded to the user's computer system for processing by the software. Alternatively, the video data stream 14 may be streamed to the user while the camera 12 is generating the video data stream; as the video data stream 14 is generated and delivered to the user the software process the video data stream 14.

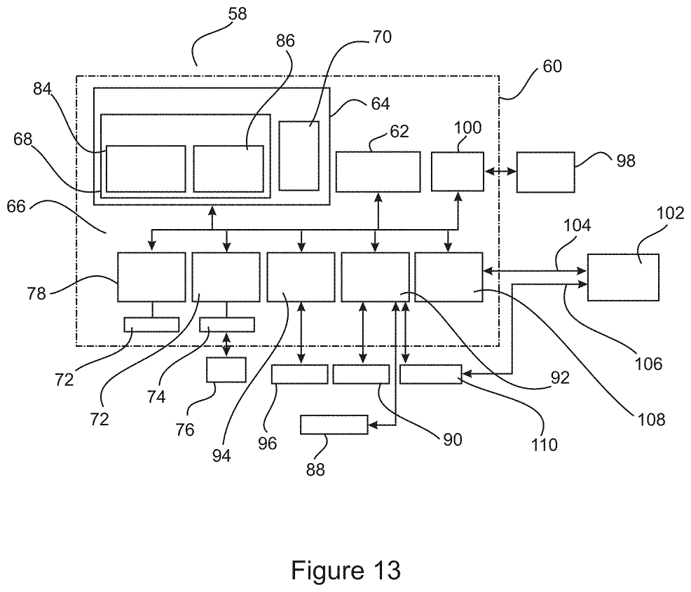

In a particular arrangement, the video processing sub-system 16 comprises one or more software modules generated using (1) software libraries for dataflow programming such as TensorFlow and (2) deep learning software frameworks. The video processing sub-system 16 also comprises detection software modules generated using MobilNet SSD and YOLO as well as training data sets generated using WderFace, ImageNet and Openlmages. Python is the preferred computer language for this particular arrangement. The software modules of the video processing sub-system 16 may be stored in the form of instructions in the system memory 64—see FIG. 13. In a particular arrangement, the visualisation sub-system 20 comprises one or more software modules generated using OpenCV, FFMPEG and Numpy libraries. Python is the preferred computer language for this particular arrangement. The software modules of the visualisation sub-system 20 may be stored in the form of instructions in the system memory 64.

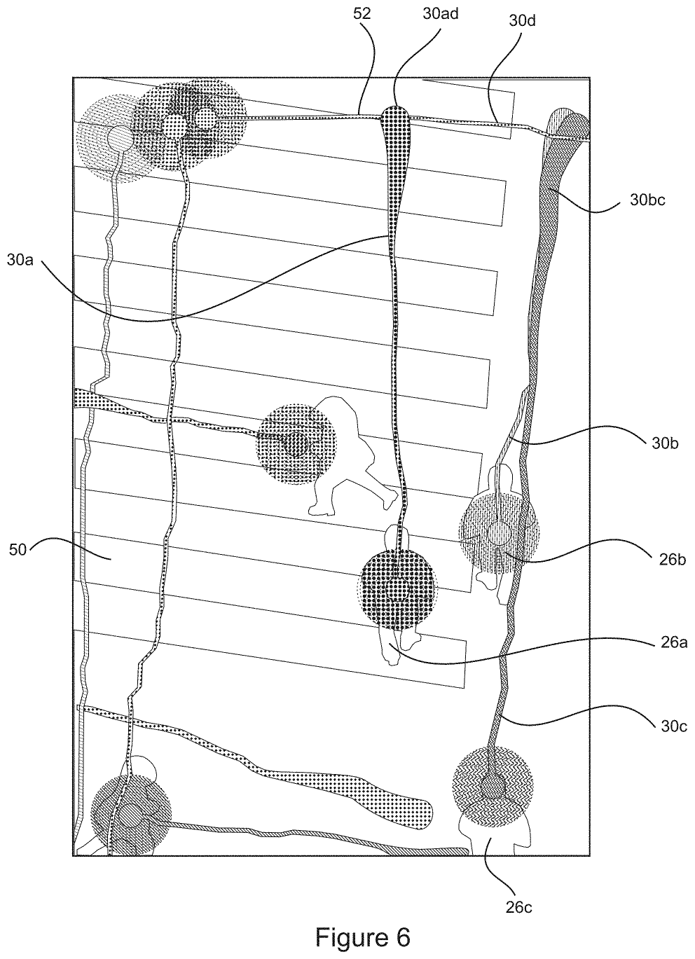

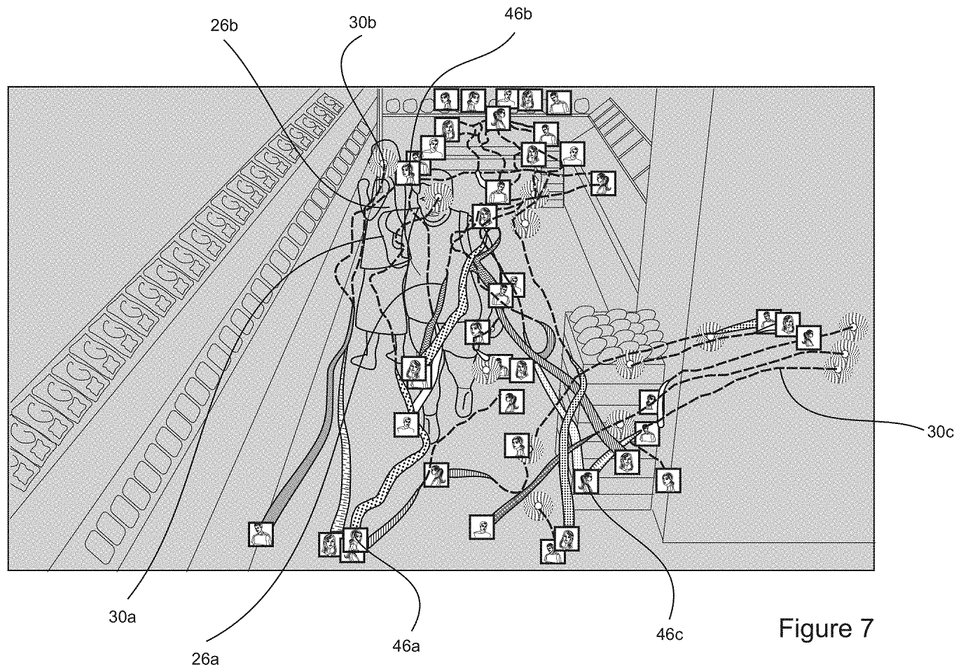

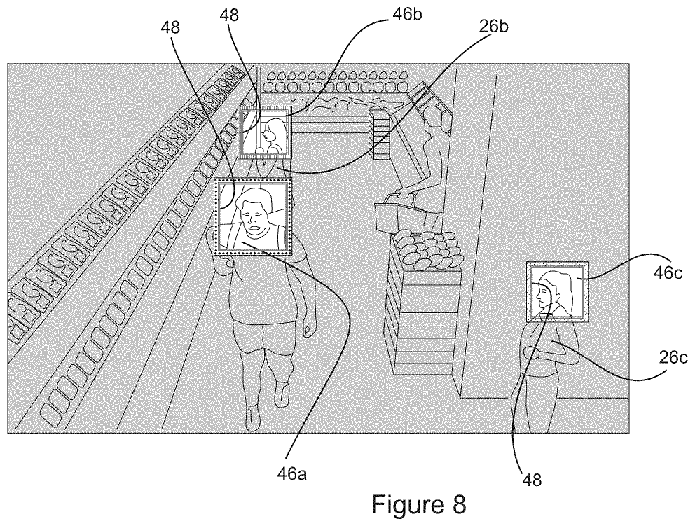

Further, the system 10 is adapted to receive a video data stream 14 from a camera 12 that capture images from a particular scene (the input images) having a background image comprising entities 26 such as persons and vehicles and where events such as movement of the entities 26 may occur. The scene may be, for example, a striped footpath 50 (see FIG. 6) permitting the persons to cross a particular street on which the vehicles travel. Alternatively, the scene may be an aisle within a supermarket for persons to view products that are being offered for sale (see FIGS. 7 and 8).

In operation, the system 10 processes the video data stream 14 to generate the sensory representations 22 to be displaced in a user interface 24 operatively connected to the system 10. In particular, the captured video stream 14 is processed in the video processing sub-system 16 generating the meta-data 18 (detection meta-data 18a and a tracking meta-data 18b) and the meta-data 18 is transferred to the video visualisation sub-system 20 for processing the meta-data 18 to obtain sensory representations 22 of the meta-data 18 representing, for example, the entities 26 and events depicted in the video data stream 14. The sensory representations 22 are then applied to the background image generating a visualised imagery for viewing by a viewer in the user interface 24.

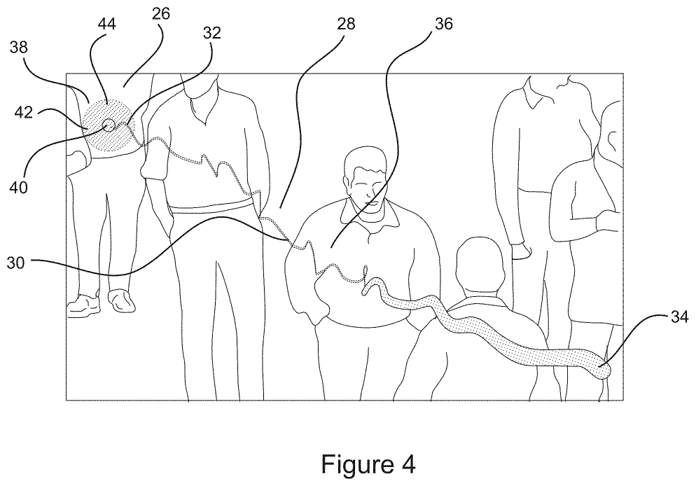

In a particular arrangement, the sensory representations 22 may be applied onto the background image forming a static image as the ones shown in FIGS. 4 to 8. In an alternative arrangement the sensory representations 22 may be applied onto the background image forming a video (referred to as the visualised video). The visualised video permits the viewer to view a video (the visualised video) of the background image onto which the sensory representations 22 have been applied.

The sensory representations 22 generated in the video visualisation sub-system 20 are the result of data visualisation processes that generate interactive, sensory representations 22 of the meta-data 18 in a form that facilitates the viewers explore and understand the events depicted in the video data stream such as particular behaviors of the detected entities—for example, a particular trajectory taken by a particular detected entity. In accordance with the present embodiment of the invention, the sensory representations 22 may take the form as traces acting as marks given evidence of the presence, existence or actions of the entities 26 and events depicted in the video data stream 14. Examples, of such traces may be lines 30 (see FIG. 4).

Alternatively, the traces may take the form of objects for highlighting, for example, the entities 26. For example, a geometrical shape (such as a square or box) may be used to surround the entity 26. By surrounding the entity 26 with the geometrical shape the entity that has been detected may be highlighted for facilitating visualisation by the user of the present computer system.

In accordance with the present embodiment of the invention, the generated sensory representations 22 (such as visual representations 28—see FIG. 4) are configured in order that users that have little knowledge of computer vision and data visualisation techniques (referred to as viewers) may view the images displayed in the user interface for recognising the entities depicted in the video data steam 14 and gaining an understanding of the particular behaviors of the detected entities and potential relational actions that may have occurred between the detected entities and/or between the detected entities and the background image such a particular item at an aisle of a supermarket.

In a particular arrangement of the present embodiment of the invention, during the visualisation process particular styling methods are used that make the visual representations 28 (generated during the visualisation process) more understandable to the viewers. In particular, the particular styling methods used during the visualisation process comprise:
Visualisation of the background image of the video stream 14 for creating a contrast between the sensory representations 22 and the visualised background image resulting in that the sensory representations 22 stand out facilitating viewing of the sensory representations 22.
Selecting an arbitrary number of distinct characteristics (such as colours, gradient, texture and/or patterns among others) facilitating viewing of the sensory representations 22 and improving the visual appeal of the generated static or video image.
Stylising the sensory representations 22 to form semi-transparent lines 30 with varying thickness representing the trajectories of moving entities 26 to show the start and end of the trajectories.
Animating the lines 30 by speeding up the visualised video to show how the trajectories of the moving entities develop over time.

### Trajectory of Detected Entity

Referring now to FIG. 4, as mentioned before, particular behaviors of detected entities 26 may be tracked; for example, movement of a detected entity 26 within a particular space over a particular period of time may be tracked. The tracking meta-data 18b obtained via the video processing sub-system 16 may be processed using the video visualisation sub-system 20 for generating a visual representation 28 that permits the viewer to gain a clear understanding of the trajectory that the detected entity 26 took during movement of the detected entity 26; in particular, the visual representation 28 permits the viewer to gain knowledge of: (1) the positon of the detected entity along the trajectory at any time and (2) the starting and ending points of the trajectory .

In the particular arrangement shown in the figures, the visual representation 28 representing the trajectory of the detected entity 26 comprises a line 30 which thickness varies in accordance with the movement of the detected entity 26 to represent the position of the entity 26 over time. The line 30 comprises a starting point 32 representing the start of the entity's trajectory, an ending point 34 representing the end of the entity's trajectory, and a centre section 36 representing the entity's trajectory between the start and end of the entity's trajectory.

As shown in FIG. 4, the line 30 at its starting point 32 is thinnest denoting the start of the entity's trajectory and the line 30 at its ending point 34 is thickest denoting the end of the entity's trajectory. The thickness of the line 30 (in particular of its centre section 36 as it extends from its starting point 32 to its ending point 34) gradually increases until the line 30 reaches its thickest portion at the ending point 34. One of the objectives of providing this particular stylization to the visual representation 28 of the entity's trajectory (the line 30) is to give the viewer particular information on how the detected entity 26 moves across a particular space over a particular period of time.

The line 30 also comprises a cap 38 having an inner circle 40 and an outer circle 42 surrounding the inner circle 40 in a concentric relationship with respect to each other. As shown in FIG. 4, the cap 38 is located at the starting point 32 of the line 30 to denote that, at that particular location, the entity's trajectory starts. Alternatively, the cap may be located at the ending point of the line 30.

Further, the inner circle 40 and the outer circle 42 are configured to show a contrast between both circles 40 and 42; in particular, the outer circle 42 is semi-transparent and the inner circle 40 is opaque. This particular arrangement is particular useful because it draws the attention of the viewer to the cap 38 but without blocking the background image. The background image is not blocked because the outer circle 42 is semi-transparent; thus, still permitting the viewer to view areas of the background image located at the starting point 32 of the line 30. In fact, as shown in FIG. 3, particular areas (such as the image of the bag strap 44) of the entity 26, at the location where the cap 38 is positioned, are still visible even though the particular areas are covered with the cap 38. In alternative arrangements, the cap 38 may take a shape other than a circle.

Furthermore, the line 30 as well as the cap 48 may be coloured with the same colour. As will be described later, a specific colour may be assigned to each of the particular detected entities 26 and that specific colour will be used continuously for the particular detected entity 26 throughout the processing of the video data stream. In this manner, the lines 30 of each moving entities 26 may be told apart from each other—this is particularly useful if any scene captured by the camera 12 is relative crowded due to a relative number of entities 26 being present at the scene at a particular moment in time such as the scene that generated the visualised imagery shown in FIG. 7.

Further, as can be appreciated in FIG. 7, the ending point 34 of a particular line 30 (such as 30a) representing the trajectory of a particular entity 26 (such as 26a) comprises a box 46 (such as box 46a) surrounding the face of the moving entity 26a. This particular arrangement is particular useful because it permits, by viewing the box 46, identifying the entity 26 which moved along the trajectory represented by the line 30a. Thus, it is relative easy to clearly identify which entity 26 took which trajectory represented by a line 30. This can be most useful in shoplifting scenarios to identify the alleged shoplifter whose line 30 indicates that the entity 26 was the last one pass by the shoplifted product; in fact, for identification of the alleged shoplifter it is only necessary to inspect the box 46 attached to ending point 34 of the alleged shoplifter's line 30.

As mentioned before, the drawings are schematic drawings and due the Patent Cooperation Treaty not making any provisions for colour drawings all boxes 46 are shown as having a black border; however, in an arrangement, the border of each box 46 has assigned a particular characteristic (a pattern or colour) that coincides with the characteristic of its corresponding line 30.

Furthermore, for illustration purposes, the lines 30 are shown initially as having a particular characteristic (such as a pattern or colour) at their thicker sections and having a dotted section ending in caps 38. In accordance with an arrangement, the entire extension of each line 30 has the particular characteristic (pattern or colour) with the cap 38 being assigned the same particular characteristic of its corresponding line 30.

### Bounding Boxes

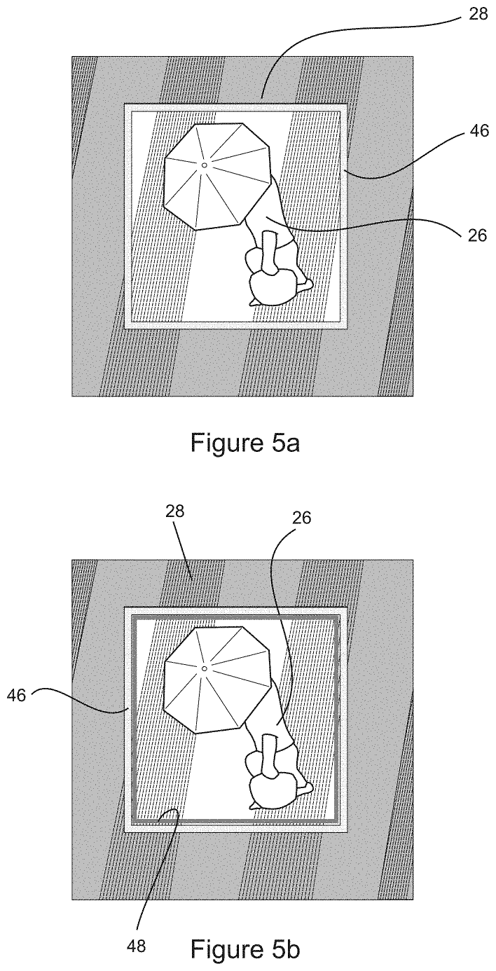

Referring now to FIGS. 5a and 5b, as mentioned before, entity detection may result in generation of a visual representation 28 used for highlighting the detected entity 26. In accordance with the present embodiment of the invention, the particular visual representation 28 permitting identification of the entity 26 comprises a geometrical shape such as a two-dimensional shape defining a border that surrounds the detected entity 26. In alternative arrangements, the geometrical shape may be a three-dimensional shape

FIGS. 5a and 5b show a particular arrangement of visual representation 28 used for highlighting a particular detected entity 26. As shown, the visual representation 28 comprises a square shaped border 46 (referred to as box 46) of a particular colour; for example, the colour of the box 46 used for highlighting a particular detected entity 26 may be the same colour used for the line 30 representing the trajectory of the particular detected entity 26 when tracking movement of the particular detected entity 26.

Further, as can be appreciated in FIGS. 5a and 5b and as will be described at a later stage, the visualisation process comprises generating a visualisation of the background image of the video stream 14 to improve visibility of the box 46; in particular, at least a portion of the background image (such as the striped pedestrian path shown in FIGS. 5a and 5b) located outside the box 46 is darkened to improve the contrast between the box 46 and the background image. In contrast, the background image within box 46 has not been darkened so as not to reduce visibility of the detail that makes up the detected entity 26 permitting, for example, identification of the detected entity 26 or gathering of, for example, any relevant detail of the entity 26 for future recognition.

Furthermore, in the particular arrangement shown in FIG. 5b, the visual representation 28 comprise a box 46 including a padding region 48 surrounding the detected entity 26 and being surrounded by the box 46. As shown in FIG. 5b, the padding region 48 is defined by the darkened background. Also, in this particular arrangement, the thickness of the padding and the thickness of outline of the box 46 are the same (for example, substantially about 2 pixels at 72 DPI). Inclusion of the padding region 48 will essentially create a relative thick edge, having a bright and a dark component, allowing it to stand out well against any colour that the background image may have.

Moreover, as mentioned before the lines 30 including the caps 38 (representing the trajectories of the moving detected entities 26) and the boxes 46 (highlighting the detected entities 26) are coloured; and each particular colour will be assigned to a specific entity and that particular colour may be used exclusively for that specific entity 26 throughout the processing of the video data stream 14. Alternatively, a plurality of entities 26 having the same attribute (for example, being all members of the same gang) may be assigned the same colour; this alternative arrangement is particularly useful because it permits tagging of the entities 26 of the same group (such as a gang) to easily identify the location and movement of the entire group as a whole within a crowded scene.

FIG. 6 shows a static image of the background of a particular video stream obtained from the camera 12 taking for a particular period of time onto which visual representations 28 (generated by the video visualisation sub-system 20) for each of detected entities 26 (captured by the camera 12 during the particular period of time) have been applied thereon.

As shown in FIG. 6, the particular stylization chosen for the visual representations 28 (the line 30) for representing the trajectories of the detected entities 26 permit the viewer without any difficulty to gain an understanding of the trajectory of each of the detected entities 26. Further, each line 30 comprises a cap 38 (see FIG. 4), wherein each cap 38 comprises the same characteristic (such as colour) that than its corresponding line 30.

Furthermore, in accordance with a particular arrangement of the present embodiment of the invention, the colours for the lines 30 (including the caps 38) and the boxes 46 will be applied onto the background image using the additive blend mode. Additive blend modes adds pixel values of one layer with another layer producing the same colour or a lighter colour.

In fact, as shown in FIG. 6, in connection with the detected entity 26a, the line 30a as it extends over the striped footpath 50 having white stripes 52, changes colour at the particular locations where particular portions of the line 30a are applied onto the white stripes 52; this results in a change of colour (a lighter one) for each of the particular portions of the line 30a.

Similarly, as two lines (such as 30b and 30b) are overlaid on the top of each other, the colours will add up in intensity (brightness) resulting in a new appearance 30bc; the same occurs with lines 30a and 30d resulting in a new appearance 30ad as shown in FIG. 6.

The use of additive blend modes is particularly advantageous because the visual representations 28 gain a bright, semi-translucent look; and, it serves two purposes: firstly, as mentioned above, as two lines 30 are overlaid on top of each other, their colours will add up in intensity (brightness) and it will be possible for the viewers to immediately get a visual sense of how crowed the scene is and secondly it creates a unique and appealing stylization to the visualised imagery generated by the system 10 being suitable as a branding mechanism.

As mentioned before, due to no being able to present coloured drawings in FIG. 6, the sections having the new appearances (30bc and 30ad) mentioned in the previous paragraph are not clearly visible; however, when a colour are assigned to each line 30, the new sections with new appearances are clearly visible by the user.

### Background Processing

Moreover, it was mentioned before that the visualisation process comprises generating a visualisation of the background image of the scene captured by the camera 12 with the objective of applying thereon the visual representations 18. In accordance with the present embodiment of the invention there are several options for visualisation of the background image.

In a particular arrangement, the background image may be completely desaturated to, for example, grey-scale. This is particularly advantageous because it makes the coloured visual representations 28 (such as the lines 30 or boxes 46) to stand out when applied on the desaturated background. In particular, desaturating the background permits the first portions of the lines 30 (which are typically relative thin due to representing the initial stages of the trajectories of the detected entities 26); this can be best appreciated in FIG. 7 showing a static image of a desaturated background onto which visual representations 28 such as the lines 30 and boxes 46 related to a plurality of detected entities 26 (such as 26a to 26c) have been applied to the desaturated background.

In another arrangement, the brightness of the background image can be reduced with the objective of darkening the background image; as an example, the brightness may be reduced to 50%-70%.

In an arrangement, the background image may be selectively darkened resulting in that particular portions of the background image may not be darkened or may be darkened less than other portions of the background image. A practical application of selective darkening is shown in FIGS. 5 and 8 and it occurs when an entity 26 is detected. As mentioned before, in connection with FIGS. 5a and 5b, darkening of the background permits creating contrast between the background and the visual representations 28 such as the box 46 resulting in a highlighting of the box 46. Further, it was also mentioned that the background (excluding the padding 48) within the box 46 is not darkened permitting identification of particular details of the entity 26.

Similarly, FIG. 8 shows another example of selective darkening of the background image. As shown in FIG. 8, the background image has been selectively darkened generating a contrast between the boxes 46a to 46c of detected entities 26a to 26c but omitting darkening of the background at the particular locations where the upper bodies including the faces of the detected entities 26a to 26c are located. As can be appreciated from FIG. 8, the selective darkening of the background image permits generating a contrast between the background image and the boxes 46 but maintaining the interior of the boxes 46 (expect for the padding 48) with the original brightness of the background image. This ensures that the contour of the boxes 46 remain visible and that the faces of the detected entities 26 may still be clearly identified.

In further arrangements, the visualisation process may comprise generating a visual representation of the background image excluding presence of the entities; this can be done for video streams obtained from fixed angle video cameras. In particular, by taking the median value of each pixel it is possible to generate a background image that would correspond to the background image of a video data stream obtained by the camera 12 when capturing the original scene without the entities 26. The goal of this background visualisation process is to create an uncluttered, static image without the entities 26 to be used, for example, as a basis for applying particular visual representations 28.

### Colour Palette Selection

In accordance with a particular arrangement of the present embodiment of the invention, the computer system 10 generates a bespoke colour palette for each visualisation representation 28, for example: the line 30 including caps 38, and the box 46. As mentioned before, in a particular arrangement each entity 26 is assigned a particular colour used for colouring the line 30 including the caps 8 and box 46 of each entity 26. In this particular arrangement of the present embodiment of the invention, the colour to be assigned to each entity 26 is chosen from the generated bespoke colour palette.

The colours of the bespoke colour palette are generated at a saturation level of between 80-100% and a brightness of 100%. In this manner, by assigning these colours to the visual representations 22, the visual representations 22 will stand out against the background and make the visual representations 22 visually appealing.

Further, each colour (of the generated bespoke colour palette) will only differ in its hue value. In particular, the hue value will be uniformly distributed across an arbitrary range from 0 degrees to 360 degrees. In the nominal case, the hue value will be distributed over the entire spectrum. However, in alternative arrangements, an offset hue value and range will be set to achieve a tailored, branded look (for example: only shades of green, or only shades of blue, among other options).

A particular palette 54 of the present embodiment of the invention (referred to as the default palette) uses 0.85 saturation, 1.0 brightness, and distributes the colours over the entire hue spectrum. This particular palette 54 provides the maximum difference and clarity between the visual representations 22. FIG. 9 shows a particular example of palette 54 for n=10.

Another palette 56 of the present embodiment of the invention (referred to as the branding palette) uses 0.85 saturation, 1.0 brightness, and distributes the colours over a 0.3 range of hue, at a 0.9 offset. This particular palette 56 is a blue colour palette to help reinforce the brand colours the visual representations 22. FIG. 10 shows a particular example of palette 56 for n=10.

FIGS. 4 to 8 show static images including visual representations 22 generated by the system 10 in accordance with the present embodiment of the invention. However, as mentioned before, the sensory representations 22 may be applied onto the visualised background image in the form of a video (referred to as the visualised video) permitting the viewer to view a video (the visualised video) of the visualised background onto which the sensory representations 22 have been applied.

### Event Filtering

In accordance with particular arrangements of the invention, the system 10 is configured for providing the option of filtering out from the visualised video particular instances of the scene captured by the camera 12. For example, the particular instances of the scene that may be of no interest to the viewer may be filtered out; in particular, instances where no activity is detected by the video processing sub-system 16 may be filtered out by, for example, speeding up the visualised video (for example, between 2× to 50× of original speed). Upon detection of return of activity—for example, the video processing sub-system 16 may detect an entity 26 or a particular event—the visualised video will slow back down to its nominal speed. In a particular arrangement, the visualised video will slow down 1.5 second after detection of an entity 26 or event has occurred and the visualised video will speed up 1.5 second prior detection of an entity 26 or of the occurrence of an event.

### Trajectory Rendering

Further, in accordance with other arrangements of the present embodiment of the invention, in the visualised video, the lines 30 (representing the trajectories of detected entities 26) may be rendered from their starting point 32 and animated towards their ending point 34. Once the lines 30 have reached their end portions, the thickness and opacity of the lines 30 will slowly fade out over a relative short period of time such as a few seconds. The purpose of this rendering method is to give the viewer a sense of how the lines 30 (and thereof the trajectories of the tracked entities 26) develop over time, in relation to each other, and also to give to the viewer a general sense of how all lines 30 develop over a relative period of time. In a particular arrangements in addition to rendering the lines 30 as described above, the visualised video will be sped up abut 2× to 8× of the original video playback speed.

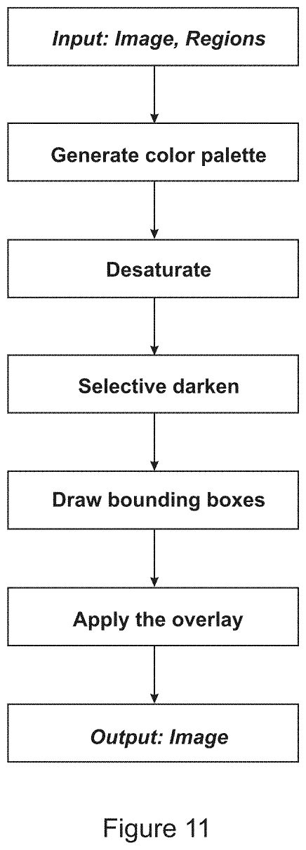

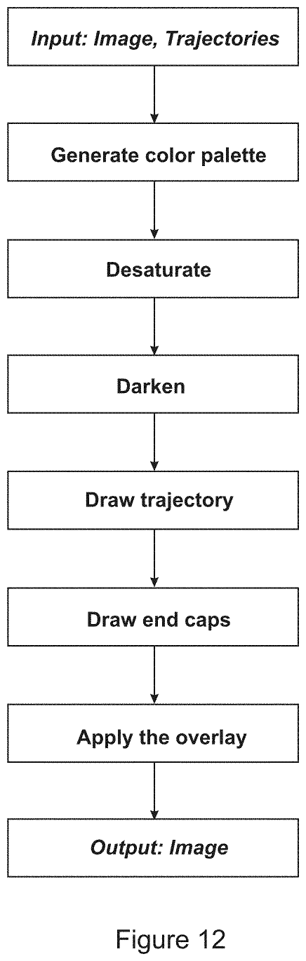

FIGS. 11 and 12 show flowcharts illustrating, respectively, particular arrangements of the processes conducted in the video visualisation module 20 for rendering the bounding boxes 46 and trajectories (lines 30) of the detected entities 26.

FIG. 11 illustrates the process for rendering the bounding boxes 46. In particular, the process for rendering a particular box 46 comprises receiving the coordinates (spatial coordinates x, y and width and height) of the box 46 that will be surrounding the detected entity 26. The coordinates (part of the detection and tracking meta-data 18) are generated at the video processing module and transferred to the video visualisation module 20. In a particular arrangement, the coordinates are in the form of RGB (red, green, blue) bitmap of a particular frame to be rendered for defining the box 46 and of regions listing one or more bounding boxes 46 defined by their coordinates.

FIG. 12 illustrates the process for rendering the lines 30. In particular, the process for drawing a line 30 (the detected entity's trajectory) comprises receiving the coordinates of the trajectory (line 30) that the detected entity 26 in motion follows as a function of time. The coordinates (part of the detection and tracking meta-data 18) are generated at the video processing module and transferred to the video visualisation module 20. In a particular arrangement, the coordinates are in the form of a RGB bitmap of a particular frame to be rendered for defining the box 46 and one or more trajectories to be rendered defined by a chronological series of bounding boxes for each trajectory.

Referring now to FIGS. 11 and 12, the step for generating the colour palette for the bounding boxes 46 or lines 30 comprises generating a distinct colour for each of the bounding boxes 46 or lines 30. The colours are generated in HSV colour space normalised between 0.0 and 1.0 for all values converting it back to the RGB colour space. For each colour (indexed between i=0 and i=n, n being the amount of colours based on the amount of bounding boxes 46 or lines 30), particular values of the hue of each colour are assigned based on the following parameters:
a. hue_offset parameter: The offset for the hue is default to 0.0. This allows to choose what shade of colour to start the palette from (e.g. blue, green, etc) for branding purposes.
b. hue_range parameter: The degree to which we will distribute the n colours along the hue spectrum.

The particular values of the hue of each colour are obtained using the formula below:

hue=hue_offset+hue_range*(i/n)

saturation=0.9 and brightness=1.0.

The step of desaturation comprises common colour conversion techniques such as selecting the shade of gray. The shade of gray is based on the existing luminosity level and obtained via the following formula: gray=(red*0.299)+(green*0.59)+(blue*0.11). Desaturation occurs by setting each value in the RGB bitmap to the calculated gray value. The step of darken the image (used for rendering the line 30) such as the background image comprises dividing each value in the RGB bitmap by 2 element wise.

The step of selective darkening (used for rendering the box 46) comprises applying the darken technique mentioned in the previous paragraph to only particular pixels of the images; such as pixels that do not intersect any area in any of the input bounding boxes.

The step of drawing the boxes 46 comprises:
a. selection a corresponding colour generated above for each box 46,;
b. each box is padded by a particular number (P) of pixels, P is selected in proportion to the image size (for example 2 pixels). This is done by increasing the width and height of each box by 2P, whilst keeping the box centre on its particular x and y coordinate;
c. the lines of each box 46 are then drawn onto a black background, with the selected colour and with a particular thickness T (such as T=2 pixels, but also can be varied in proportion to the image size to be surrounded by the box 46); and
d. application of the above drawn image as an overlay onto the input background image.

The step of drawing the lines 30 comprises:
a. defining the trajectory as a sequence of tracklets; each tracklet (t) being tagged with a particular frame number (f), and a bounding box identification (x, y, width, height);
b. using the following parameters as a default (in alternative arrangements variation to these parameters in accordance with the size of the input image):

min_thickness=2

thickness_range=20

frame range=600
c. for each trajectory, a corresponding colour generated above is selected for rendering the corresponding line 30;
d. generating a base image comprising a black image having the same dimensions as the input image;
e. selecting a thickness value between each pair of neighbouring tracklets (tⱼ and tⱼ+1) in sequence based on the formula:

raw_progress=1−(j/total_number_of_tracklets)

progress=max(0, (3*raw_progress)−2)

thickness=min_thickness+thickness_range*progress

drawing each line as having the above calculated thickness and the selected colour onto the base image generating an overlay image; and

applying the overlay image onto the input image.

The step of drawing the caps such as the starting caps 38 of the line 30 comprises drawings two concentric circles at end of each line 30. In a particular arrangement, a first circle is drawn having a radius of 32 pixels. The colour of the first circle is of the same colour than the selected colour of the line 30, but darkened by 75%. Subsequently, a second circle (concentric with respect to the first circle) is drawn on top of the first circle, the second circle having a radius of 8 pixels and the same colour as the line 30. The radius of the circles may vary in accordance with the size of the input image.

The step of applying the overlay image (comprising either the bounding box 46 and/or the line 30) onto the input image comprises drawing each selected colour onto a black background image. And, producing the final output image (such as the images shown in FIGS. 4 to 8) by overlaying the produced background image onto the input image; this is done by adding up each pixel RGB value together, element-wise:

RGBoutput=RGBinput+RGBoverlay

Each channel is also capped at its maximum value, so it cannot exceed 1.0 intensity for that colour. This means that a maximal value pixel will appear white.

Particular applications of the computer-implemented method and system 10 for implementing the method may be CCTV video streams in the fields of Security/Law Enforcement, Commerce and Transport and Congestion Planning.

FIG. 13 shows a particular arrangement of a computing system 58 implementing the method for generating visualised imagery using the system 10 based on video data stream generated by the camera 12.

The computing system 58 comprises a general purpose computing device in the form of a conventional computing environment 60 (e.g. personal computer), including a processing unit 62, a system memory 64, and a system bus 66, that couples various system components including the system memory 64 to the processing unit 62. The processing unit 62 may perform arithmetic, logic and/or control operations by accessing system memory 64. The system memory 64 may store information and/or instructions for use in combination with processing unit 622. The system memory 64 may include volatile and non-volatile memory, such as random access memory (RAM) 68 and read only memory (ROM) 70. A basic input/output system (BIOS) containing the basic routines that helps to transfer information between elements within the personal computer 60, such as during start-up, may be stored in ROM 70. The system bus 68 may be any of several types of bus structures including a memory bus or memory controller, a peripheral bus, and a local bus using any of a variety of bus architectures.

The personal computer 60 may further include a hard disk drive 72 for reading from and writing to a hard disk (not shown), and an external disk drive 74 for reading from or writing to a removable disk 76. The removable disk may be a magnetic disk for a magnetic disk driver or an optical disk such as a CD ROM for an optical disk drive. The hard disk drive 72 and external disk drive 74 are connected to the system bus 66 by a hard disk drive interface 78 and an external disk drive interface 80, respectively. The drives and their associated computer-readable media provide nonvolatile storage of computer readable instructions, data structures, program modules and other data for the personal computer 60. The data structures may include relevant data of the implementation of the method for dynamically detecting and visualizing actions and events in video data streams, as described in more details below. The relevant data may be organized in a database, for example a relational or object database.

Although the exemplary environment described herein employs a hard disk (not shown) and an external (removable) disk 76, it should be appreciated by those skilled in the art that other types of computer readable media which can store data that is accessible by a computer, such as magnetic cassettes, flash memory cards, digital video disks, random access memories, read only memories, and the like, may also be used in the exemplary operating environment.

A number of program modules (also referred to as software modules) may be stored on the hard disk, external (removable) disk 76, ROM 70 or RAM 68, including an operating system (not shown), one or more application programs 84, other program modules (not shown), and program data 86. The application programs may include at least a part of the system 10 depicted in FIG. 3 for generating the visualised imagery such as shown in FIGS. 4 to 8.

The viewer may enter commands and information, as discussed below, into the personal computer 60 through input devices such as keyboard 88 and mouse 90. Other input devices (not shown) may include a microphone (or other sensors), joystick, game pad, scanner, or the like. These and other input devices may be connected to the processing unit 62 through a serial port interface 92 that is coupled to the system bus 66, or may be collected by other interfaces, such as a parallel port interface 94, game port or a universal serial bus (USB). Further, information may be printed using printer 96. The printer 96, and other parallel input/output devices may be connected to the processing unit 62 through parallel port interface 94. A monitor 98 or other type of display device is also connected to the system bus 66 via an interface, such as a video input/output 100 may be connected to one or more surveillance cameras 12 that provide one or more video streams 14. In addition to the monitor, computing environment 60 may include other peripheral output devices (not shown), such as speakers or other audible output.

The computing environment 60 may communicate with other electronic devices such as a computer, telephone (wired or wireless), personal digital assistant, television, surveillance video cameras or the like. To communicate, the computer environment 60 may operate in a networked environment using connections to one or more electronic devices. FIG. 13 depicts the computer environment networked with remote computer 102. The remote computer 102 may be another computing environment such as a server, a router, a network PC, a peer device or other common network node, and may include many or all of the elements described above relative to the computing environment 60. The logical connections depicted in FIG. 13 include a local area network (LAN) 104 and a wide area network (WAN) 106. Such networking environments are commonplace in offices, enterprise-wide computer networks, intranets and the Internet.

When used in a LAN networking environment, the computing environment 60 may be connected to the LAN 104 through a network I/O 108. When used in a WAN networking environment, the computing environment 60 may include a modem 110 or other means for establishing communications over the WAN 106. The modem 110, which may be internal or external to computing environment 60, is connected to the system bus 66 via the serial port interface 92. In a networked environment, program modules depicted relative to the computing environment 60, or portions thereof, may be stored in a remote memory storage device resident on or accessible to remote computer 102. Furthermore other data relevant to the application of the insurance claim management evaluation method (described in more detail further below) may be resident on or accessible via the remote computer 102. The data may be stored for example in an object or a relation database. It will be appreciated that the network connections shown are exemplary and other means of establishing a communications link between the electronic devices may be used.

Modifications and variations as would be apparent to a skilled addressee are deemed to be within the scope of the present invention. For example, the particular arrangement of the present embodiment of the invention has been described in relation to assigning to each sensory representation 22 or a group of sensory representation 22 that have a particular attribute in common, particular characteristics such as colour for identification purposes. In alternative arrangements, the particular characteristics may be: type of lines (dotted, dashed, dash dotted lines etc. . . .), gradients, patterns or textures may be assigned to each sensory representation 22 or a group of sensory representation 22 that have a particular attribute in common.

Further, it should be appreciated that the scope of the invention is not limited to the scope of the embodiments disclosed.

Throughout this specification, unless the context requires otherwise, the word “comprise” or variations such as “comprises” or “comprising”, will be understood to imply the inclusion of a stated integer or group of integers but not the exclusion of any other integer or group of integers.

1. A computer system for detecting and tracking events comprising one or more entities depicted in a video data stream comprising a background image including the entities, the computer system being adapted to receive the video data stream for processing thereof, and the computer system comprising:
a computing system comprising at least one processor for executing executable code and at least one memory device communicating with the processor accessible via a computer network and storing the executable code, wherein the executable code, when executed by the at least one processor, causes the at least one processor to:
i. scan the video data stream for detecting the one or more entities and one or more trajectories taken by the entities, and the background image;
ii. process the detected entities, the trajectories, and the background image;
iii. generate detection meta-data concerning detected entity and tracking meta-data concerning the detected trajectories;
iv. generate meta-data representative of the background image;
v. process the meta-data for generating sensory representations, the sensory representations comprising any one of:
vi. visual representations of the tracked events comprising a trace representative of the trajectory of the event, the trace being configured for representing the position of the entity over time along the trajectory;
vii. visual representations configured for highlighting the entity in the background image; and
viii. visualisation of the background image.

2. A computer system in accordance with claim 1 wherein the trace is configured in order to represent movement of the detected entity.

3. A computer system in accordance with claim 1 wherein the trace comprises a cap at its starting point denoting the starting point of the trace.

4. A computer system in accordance with claim 1 wherein the trace comprises a cap at its ending point to denote the ending point of the trace.

5. A computer system in accordance with claim 1 wherein a particular characteristic is assigned to each detected entity and that particular characteristic will be used continuously for the particular detected entity throughout the processing of the video data stream.

6. A computer system in accordance with claim 5 wherein the cap comprises an inner circle and an outer circle surrounding the inner circle in a concentric relationship with respect to each other, the inner circle and the outer circle being configured to show a contrast between both circles.

7. A computer system in accordance with claim 5 wherein detected entities who share one or more attributes are assigned the same characteristic.

8. A computer system in accordance with claim 5 wherein, the trace and the cap are assigned the same characteristic.

9. A computer system in accordance with claim 1 wherein the trace comprises a visual representation permitting identification of the entity.

10. A computer system in accordance with claim 9 wherein the visual representation permitting identification of the entity comprises generating a visualisation of the background image of the video stream.

11. A computer system in accordance with claim 1 wherein the executable code, when executed by the at least one processor, causes the at least one processor to generate a visualised imagery comprising visualised background image having applied thereon sensory representations of one or more detected entities and of the trajectories of the one or more detected entities.

12. A computer system in accordance with claim 11 wherein the characteristics for the visual representations will be applied onto the background image using additive blend mode.

13. A method for detecting and tracking one or more entities depicted in a video data stream comprising a background image including the entities, the method comprises
i. scanning the video data stream for detecting the one or more entities and one or more trajectories taken by the entities, and the background image;
ii. processing the detected entities, the trajectories, and the background image;
iii. generating detection meta-data concerning detected entity and tracking meta-data concerning the detected trajectories;
iv. generating meta-data representative of the background image;
v. processing the meta-data for generating sensory representations, the sensory representations comprising any one of:
vi. visual representations of the tracked events comprising a line representative of the trajectory of the event, the line being configured for representing the position of the entity over time along the trajectory;
vii. visual representations configured for highlighting the entity in the background image; and
viii. visualisation of the background image.

14. A method in accordance with claim 13 wherein the method further comprises generating a visualised imagery comprising applying the sensory representations of the one or more detected entities and of the trajectories of the one or more detected entities on the visualised background image.

15. A method in accordance with claim 14 wherein the method further comprises generating a static image comprising the visualised imagery.

16. A method in accordance with claim 14 wherein the method further comprises generating a visualised video comprising the visualised imagery.

17. A method in accordance with claim 16 wherein the method further comprises filtering out from the visualised video particular instances of the video data stream.

18. A method in accordance with claim 17 wherein filtering out comprises speeding up the visualised video.

19. A method in accordance with claim 14 wherein in the visualised video, the traces (representing the trajectories of detected entities) are rendered from their starting point and animated towards their ending point.

20. A method in accordance with claim 19 wherein when the traces have reached their end portions, the thickness and opacity of the traces will slowly fade out over a relative short period of time.

21. A method in accordance with claim 13 wherein a particular characteristic is assigned to each detected entity and that particular characteristic will be used continuously for the particular detected entity throughout the processing of the video data stream.

22. A method in accordance with claim 21 where detected entities who share one or more attributes are assigned the same characteristic.

23. A method in accordance with claim 13 wherein the visualisation of the background image comprises any one of desaturation of the background image and darkening of the background image.

24. A method in accordance with claim 13 wherein visualisation process of the background image comprise generating a visual representation of the background image excluding the presence of the entities.
